(19) United States
(12) Patent Application Publication
(10) Pub. No.: US 2020/0033260 A1
(43) Pub. Date: Jan. 30, 2020

(54) COAGULATION AND AGGREGATION REFRACTED LIGHT INDEXING DEVICE AND METHOD

(71) Applicant: Pauleologos Cusulos, Casper, WY (US)

(72) Inventor: Pauleologos Cusulos, Casper, WY (US)

(21) Appl. No.: 16/520,281

(22) Filed: Jul. 23, 2019

Related U.S. Application Data
(60) Provisional application No. 62/703,138, filed on Jul. 25, 2018.

(51) Int. Cl. G01N 21/41; B01L 3/00; B01L 9/00

(52) U.S. Cl. CPC G01N 21/4133; B01L 3/508; B01L 9/52; B01L 2300/042; B01L 2300/0663; B01L 2300/168; B01L 2300/0609; B01L 2300/0809

(57) ABSTRACT

The present invention related to a device suitable for measuring an alteration of the state of a sample, comprising: a housing having a hollow interior, a light source positioned within the interior of the housing, a sensor positioned within the hollow interior of the chamber, wherein the sensor is able to measure the light of the interior of the housing, and a computing system connected to the light source and the sensor.

### CROSS-REFERENCE TO RELATED APPLICATIONS

This application is a continuation-in-part (and claims the benefit of priority under 35 USC 120) of U.S. application No. 62/703,138 filed Jul. 25, 2018. The disclosure of the prior applications is considered part of (and is incorporated by reference in) the disclosure of this application.

### BACKGROUND OF THE INVENTION

The present invention relates to a device and method for measuring coagulation or formation in a sample, more specifically, the sample is analyzed with the use of a specific chamber to reflect and absorb the light produced by a laser to detect the final state of sample when transitions from one state to another.

A wide variety of laboratory formation testing (e.g. clotting tests) are based on the phenomenon of measuring as an endpoint, a change of phase when a test solution changes from a liquid to a coagulated form. This change is due, in some instances, to the conversion of a soluble plasma protein fibrinogen to an insoluble one, fibrin by the action of the enzyme thrombin.

The classical and standard reference blood coagulation tests involve the measurement of the time required to form a clot. Clot formation is determined by two general approaches: (a) detecting a change in the mechanical (e.g. physical) properties of the blood specimen, assuming that the clot behaves differently from the liquid in the test; or (b) measuring the optical properties of the specimen, again assuming that the clot affects the passage, reflectance or reflection of light by the blood to at least some degree, and that the test can detect such a change accurately and efficiently.

The sample taken is then analyzed in a specialized laboratory, where various different tests can be performed for measuring coagulation time, depending on the pathology or the treatment of the patient under analysis. In addition, the measured coagulation time depends on the physical method used for characterizing the coagulation phenomenon, on the way in which the sample is mixed with the coagulation factor under study (mixing time), and on the reagent used for triggering the reaction. It is therefore common practice to apply a correction in order to obtain a result that is independent of these factors.

These blood clotting tests are important to assess likelihood of bleeding in patients treated with anticoagulants or with haemostatic defects. Other clotting tests are usually carried out by mixing test plasmas with specific reagents and timing to an endpoint when the mixture suddenly clots. The clotting endpoint is usually determined physically, or optically by increased turbidity, as in a photoelectric clotting machine.

It will be clear to persons skilled in the art that there is a need for simpler, more convenient and adaptable methods and apparatus for measuring the susceptibility of liquids to coagulate over currently existing methods and apparatus. It is desirable to provide small testing modules in a portable form or alternatively can be assembled together to process much larger numbers of samples in a central laboratory.

It is desired to have a testing device and method that allows for the identification of the transition from one state to a second state of a sample.

### SUMMARY

In a first embodiment, the present invention is a device suitable for measuring an alteration of the state of a sample, comprising: a housing having a hollow interior; a light source positioned within the interior of the housing; a sensor positioned within the hollow interior of the chamber, wherein the sensor is able to measure the light characteristic of the interior of the housing; and a computing system connected to the light source and the sensor.

In a second embodiment, the present invention is a method of measuring the change in state of a specimen, the method comprising: placing a specimen within a chamber; activating, by one or more processors, a sensor, a light source, and a timer, substantially simultaneously; measuring, by one or more sensors, the change in the light characteristic measurement; and determining, by one or more processors, a reading of the sensor, when the light reading reaches a substantially constant value; and establishing, a time frame from the activation of the timer till the substantially constant light measurement reading.

### BRIEF DESCRIPTION OF THE DRAWINGS

FIG. 1A depicts a front isometric view of a chamber, in accordance with one embodiment of the present invention.

FIG. 1B depicts a front isometric view of a chamber, in accordance with one embodiment of the present invention.

FIG. 2 depicts a rear isometric view of the chamber, in accordance with one embodiment of the present invention.

FIG. 3 depicts an isometric view of the chamber with a cover removed, in accordance with one embodiment of the present invention.

FIG. 4 depicts an isometric view of the chamber with a cover removed, in accordance with another embodiment of the present invention.

FIG. 5A depicts the chamber in use in a first state, in accordance with one embodiment of the present invention.

FIG. 5B depicts the chamber in use in a second state, in accordance with one embodiment of the present invention.

FIG. 6 depicts a diagram of the electrical components of the chamber, in accordance with one embodiment of the present invention.

FIG. 7 depicts a flowchart of the operation steps of measuring the coagulation of a sample within the chamber, in accordance with one embodiment of the present invention.

### DETAILED DESCRIPTION OF THE INVENTION

The present invention provides a device and a method which are able to easily analyze the aggregation or coagulation of a sample through the formation of the aggregating or coagulating in the sample. As the sensor within the chamber is receiving data, the data is changing through the aggregation or coagulation process until the process is completed and the collected data remains constant. This is advantageous because the device requires minimum to no moving parts, other than the sample tray, there is little to no interferences with the testing process. For example, hematocrits or high lipids do not affect the testing process. The device can be constructed smaller due to the design and function of the device, which allows for the device to be portable and inexpensive compared to the current equipment used to test aggregation and coagulation

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although many methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

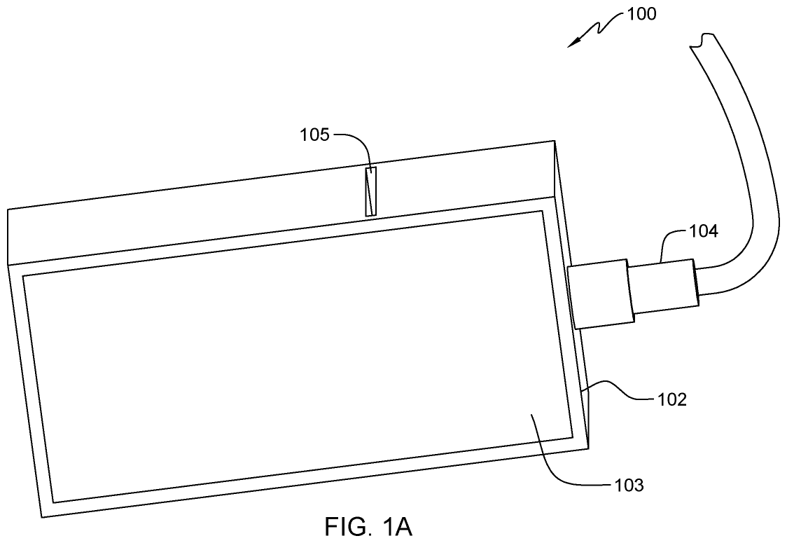

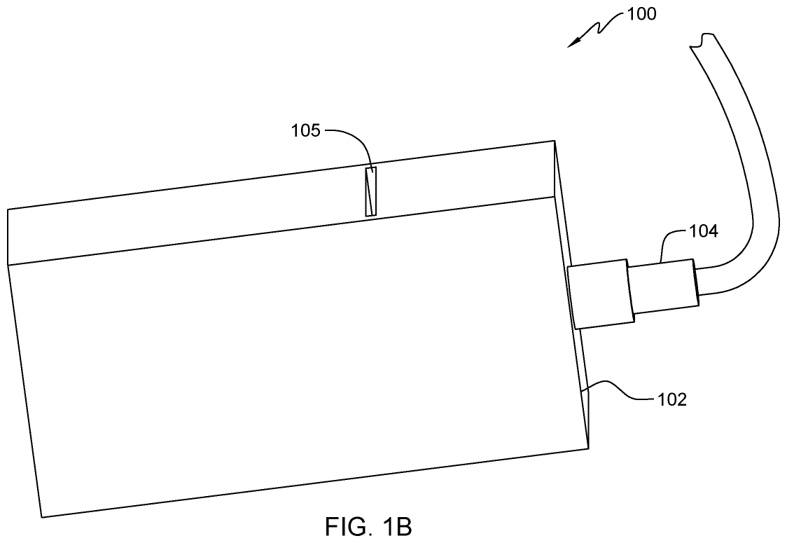

FIGS. 1A-5B depict view of a chamber 100, in accordance with several embodiment of the present invention. The chamber 100 is comprised of a case 102, a light source 104, and an electrical system 200. The case 102 is made of a substantially opaque material to reduce the ability of light to enter the inside of the case 102 when the case 102 is closed. The case 102 is made from various materials such as plastics, steel, aluminum, fiberglass, or the like, provided the material is substantially opaque. The size and shape of the case 102 is relative to the size and shape of the specimen and the light source 104.

A light source 104 is integrated into the case 102, so that the light source 104 is able to generate light within the case 102. In some embodiments, the light source 104 generates a directional projection of light energy. In other embodiments, the light generated by the light source 104 is a multi-directional projection in a parallel or unparallel structure, or the like. The light source 104 may be positioned in various locations around the cases 102 based on the chamber 100 design and the intended sample to be used within the chamber 100. The light source 104 is positioned to have an unobstructed path within the case 102. The light source 104 may be, but not limited to any sort of a lamp (incandescent, neon, etc.) or solid-state light emitting device/chip, like a LED (Light Emitting Diode), LASER chip, an electroluminescent device or others. LED is preferable in view of its low cost, low power, durability, size and range of available emission colors. Depicted in FIG. 1B is an embodiment of the chamber 100 wherein there is no cover and the interior space of the chamber 100 is only accessible through the opening 105.

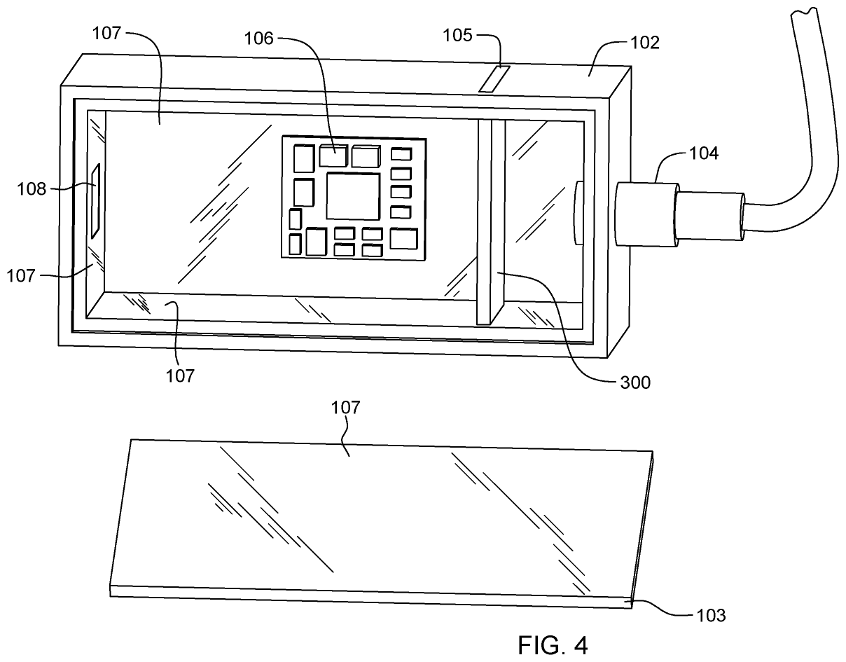

The electrical system 200, which is further described in FIG. 4, is designed to provide the power for the light source 104, communicate with a sensor 106, and communicate with various computing systems.

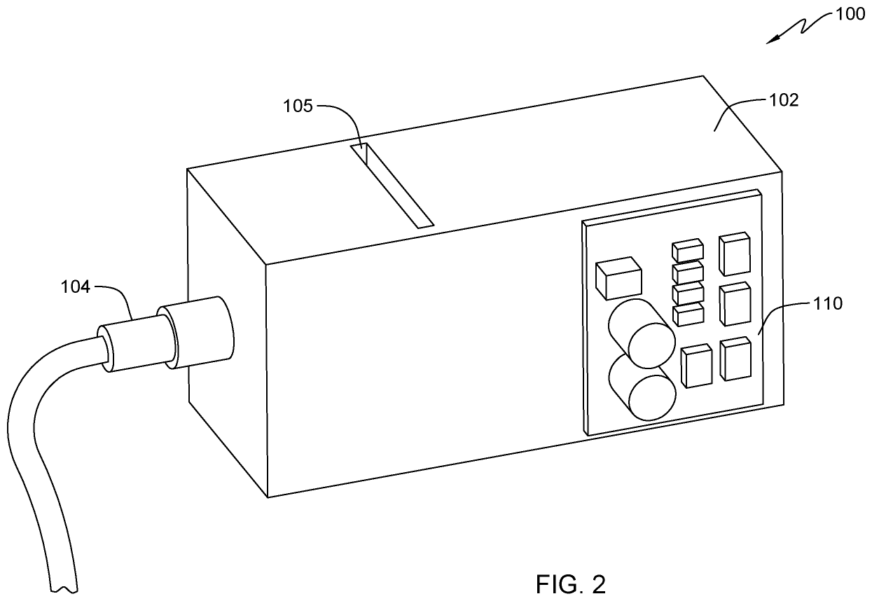

As shown in FIG. 2, in some embodiments, electrical components 110 (e.g. computing device 202) to power a light source 104 and a sensor 106 are integrated into the chamber 100. In additional embodiments, these electrical components 110 are removed from the chamber 100, and only the necessary wiring and data transferring mechanisms (e.g. wireless module, Bluetooth module, etc.) are integrated into the chamber 100, with the necessary power supply.

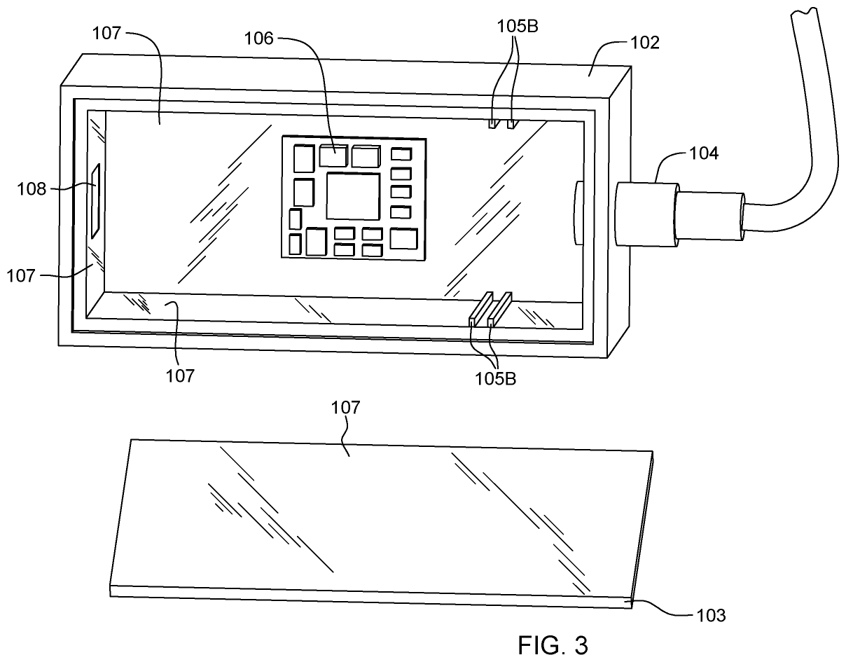

In FIGS. 3-4, the interior of the chamber 100 is shown with the cover 103 removed. The cover 103 is detachable and is able to reattach to the case 102 through various fastening means. The cover 103 is sized to fit over the opening of the case 102. In some embodiments when the cover 103 is fitted onto the case 102, the interior chamber has substantially no light entering in from the environment. In other embodiments, the cover 103 is hinged, or attached to the case 102 in a way to allow for opening and closing of the cover 103. In some embodiments, the cover 103 has an integrated lock to secure the cover 103 in place. In some embodiments, the cover 103 is removable to allow for the insertion of a test sample 300. In the depicted embodiments, an opening 105A allows for the insertion of a sample 300, without the need to remove the cover 103, or if no cover 103 is present. FIG. 4 shows the chamber 100 with a sample 300, the opening 105 allows for the insertion, and also holding of the sample 300 in place. In some embodiments, grooves or guide rails 105B are used to keeping the sample 300 in place. FIG. 4 shows one embodiment, of the sample 300 inserted in the chamber 100 between the light source 104 and the sensor 106. The sample 300 may be placed between the sensor 106 and surface 108.

Within the case 102, there is a specimen holder 105. The specimen holder 105 is designed to receive the specimen, or a specimen holder (e.g. microscope slides, or the like). In some embodiments, the specimen holder 105 is designed for a specific specimen. In additional embodiments, the specimen holder 105 is adjustable to accommodate various sized specimen. The location and placement of the specimen holder 105 is based on the size of the interior chamber, the type of sensor 106 and the type of light source 104 used.

A portion of the interior surface 107 is lined with a reflective material to allow the light produced by a light source 104 to be reflected. In some embodiments, the surface 107 is coated or has a layer of high reflective material applied to that portion of the interior surface. A second portion of the interior surface 108 has a low reflective property and is designed to absorb the light produced by the light source 104. In some embodiments, the surface 108 is coated or has a layer of low reflective material applied to that portion of the interior surface. In the depicted embodiment, the second portion of the interior surface 108 is positioned opposite the light source 104. The second portion 108 of the interior surface assists with the data collection and reduce the amount of light which reflects directly back towards the light source 104.

The sensor 106 detects and measures various metrics, measurements, characteristics, or values of the light generated by the light source 104 both before and after the light interacts with the sample 300. and transmit the received data to a computing device 202. Various light-to-voltage sensors 106 may be used depending upon the type of light source 104, and the type of specimen. The sensor 106 may measure the ambient light, the reflection and/or the reflection of the light, the dispersion of the light, the intensity of the light, lumens, absorption, transmission, various characteristics of the wavelength of the light, or other characteristics or measurable values of the light to determine when the sample 300 changes from a first state (e.g. liquid) to a second state (e.g. solid). The sensor 106 measures at least one characteristics of the light that can assist in determining the transition from the first state to a second state. In some embodiments, the sensor 106 measures light of varying wavelengths, for example visible light, infrared light, ultraviolet light, microwaves, x-rays, or the like. The sensor 106 is located within the chamber in a position that is not directly across from the light source 104. The sensor 106 can be programed to detect light levels, preferably continuous measurements of the light. In the depicted embodiment, the sensor 106 is positioned after the specimen relative to the second portion of the interior surface 108 has a low-reflective property. In some embodiment, surface 108 is substantially non-reflective. In additional embodiments, the sensor 106 is able to measure the luminosity of the interior chamber.

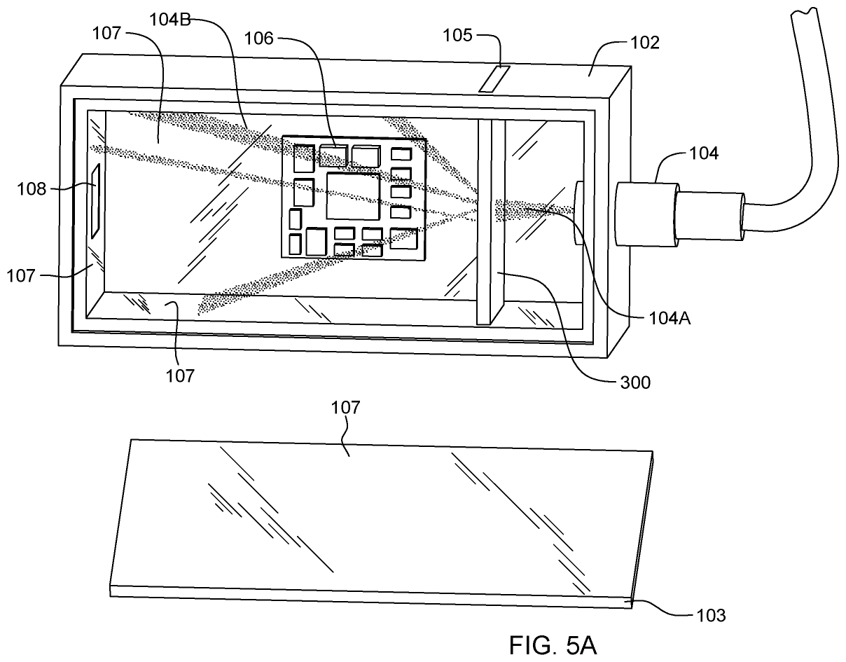

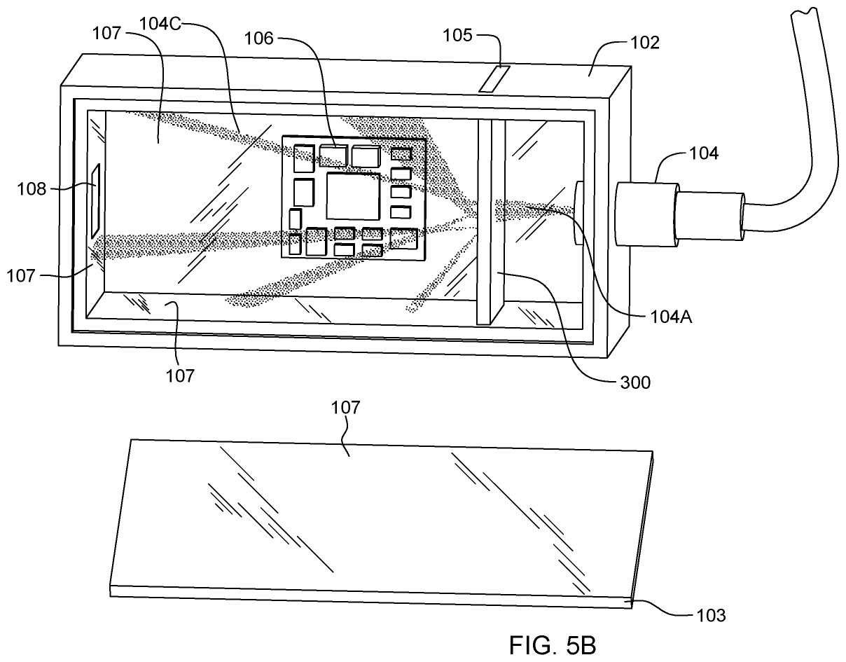

In FIGS. 5A-5B, the light source 104 is shown activated, with a beam 104A shining through sample 300 and deflecting into beams 104B. The beam 104 A is directed at surface 108 and passes in front of sensor 106. In the depicted embodiments in FIGS. 5A-5B the beam 104A is shown in a first state 104B after passing through the sample 300 and then in a second state 104C after passing through the sample 300. For exemplary purposes, the two states show the sample 300 at the start and end of its transformation. The sensor 106 detects the change in the light characteristics or value within the chamber 100 from the first state to the second state.

This is an example of one setup, as it is not a requirement for the beam 104A to pass in front of the sensor 106. The beam 104A needs to pass through sample 300, and the sensor 106 will detect the change in the light as the sample 300 changes states (e.g. solid to liquid, liquid to solid, or the like).

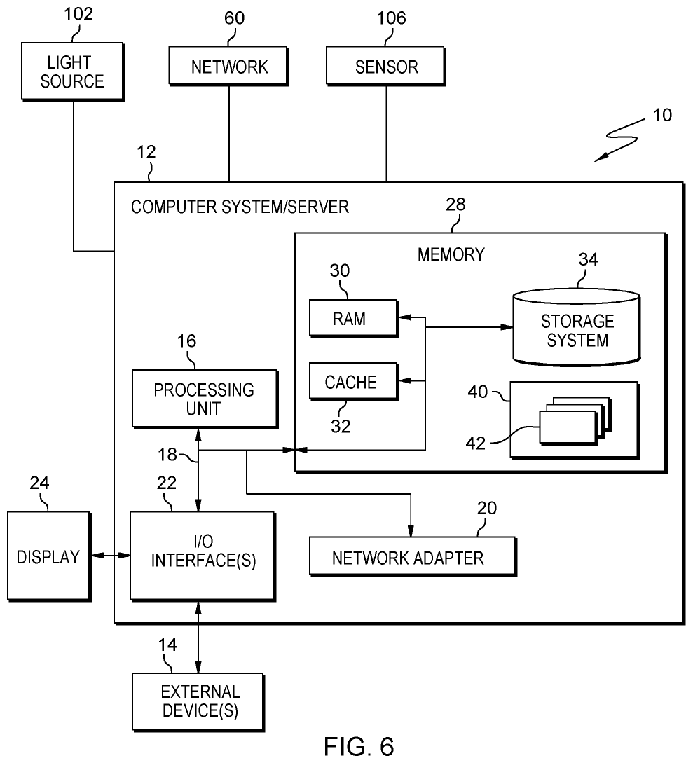

As shown in FIG. 6, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID systems, tape drives, and data archival storage systems, etc.

Network 60 may be a local area network (LAN), a wide area network (WAN) such as the Internet, any combination thereof, or any combination of connections and protocols that can support communications between computing device 10. Network 102 may include wired, wireless, or fiber optic connections. In some embodiments, the sensor 102 and the light source 106 connect directly to the network 60.

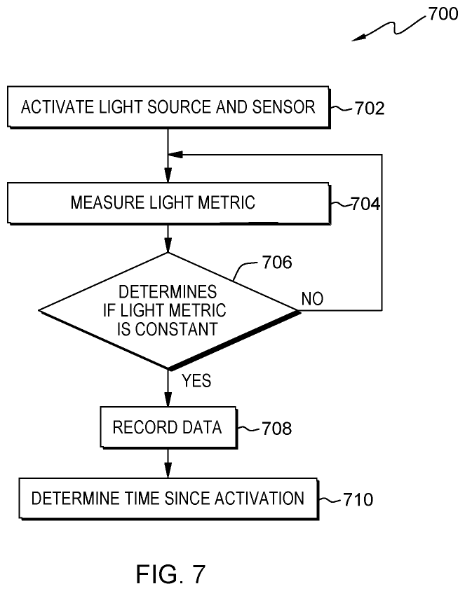

FIG. 7 depicts a flowchart of the operation steps of measuring the coagulation of a sample within the chamber, in accordance with one embodiment of the present invention.

In the depicted operational steps, the specimen is placed within the specimen holder 105 and the cover 103 is secured in place. First the light source 102 is activated and the light is directed at the specimen. As the light passes through the specimen, the light is reflected and/or refracted off of the specimen in a variety of directions. The light which passes by the sensor 106 is detected and recorded. In some embodiments, the light that is scattered and/or refracted of the specimen, and then off of the reflective interior surface creates a chaotic or inconsistent reading in the reflection, refraction, and dispersion of the light, which is measured by the sensor 106. As the specimen begins to coagulate or solidify, the reflected and/or refracted light begins to create continuous paths from the specimen and off the reflective interior surface. In other embodiments, the sensor 106 begins to measure the ambient light in the chamber, wherein a more consistent measurement is recorded due to the direction of the light reflecting, refracting, and dispersing from the sample 300 becoming substantially constant.

From the activation of the light source 102, the test is measured over time to determine the time from which the test started, to the time the sensor 106 measures the consistent light characteristics (e.g. ambient light measurement).

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A device suitable for measuring an alteration of the state of a sample, comprising:
a housing having a hollow interior;
a light source positioned within the interior of the housing;
a sensor positioned within the hollow interior of the housing; and
a computing system connected to the light source and the sensor.

2. The device of claim 1, wherein a first portion of a surface of the hollow interior of the housing, wherein the first portion of the surface has a reflective layer.

3. The device of claim 1, wherein a second portion of the surface of the hollow interior of the housing, wherein the first portion of the surface has a low reflective coating.

4. The device of claim 3, wherein the light source is directed at the low reflective coating.

5. The device of claim 1, further comprising:
a sample cartridge receiver positioned within the housing and between the light source and the sensor.

6. The device of claim 1, further comprising:
a cover attached to the housing, wherein the cover is removable to allow access to the interior of the housing.

7. The device of claim 1, further comprising:
an opening accessible from the exterior of the housing, wherein the opening is sized to accept a specimen.

8. The device of claim 7, further comprising:
a set of guide rails, wherein the guide rails are sized and positioned to receive the specimen.

9. The device of claim 1, further comprising:
a set of guide rails, wherein the guide rails are sized and positioned to receive the specimen and are accessible with the cover removed.

10. The device of claim 5, wherein, the sample cartridge receiver is adjustable.

11. A method of measuring the change in state of a specimen, the method comprising:
placing a specimen within a chamber;
activating, by one or more processors, a sensor, a light source, and a timer, substantially simultaneously;
measuring, by one or more sensors, the adjustments in the light readings;
determining, by one or more processors, a reading of the sensor, when the light readings reading reaches a substantially constant value; and
establishing, a time frame from the activation of the timer till the substantially constant light reading.

12. The method of claim 11, the method further comprising:
determining that the chamber is at a constant light reading before activating the light source and timer.

13. The method of claim 11, the method further comprising:
setting the light source to a predetermined wavelength.

14. The method of claim 11, the method further comprising:
transmitting, by one or more processors, the collected data to a computing device.

15. The method of claim 11, wherein the specimen is inserted into the chamber between the light source and the sensor.

16. The method of claim 11, wherein a first section of a surface of the chamber is coated in a reflective material.

17. The method of claim 16, wherein a second section of the surface of the chamber is covered with a low reflective material.

18. The method of claim 11, wherein the specimen is placed relative to the light source.

19. A device suitable for measuring an alteration of the state of a sample, comprising:
a housing having a hollow interior, wherein one side of the housing is removable to allow access to the hollow interior and a first portion of an interior surface has a high reflective property and a second portion of the interior surface has a low reflective property;
a light source positioned within at second portion of the interior surface of the housing;
a sample receiver positioned within the hollow interior;
a sensor positioned within the hollow interior of the housing relative to the light source and the sample receiver; and
a computing system connected to the light source and the sensor.

20. The device of claim 19, wherein the sensor measures the light refraction off the sample.
